(19) United States
(12) Patent Application Publication
(10) Pub. No.: US 2026/0126112 A1
(43) Pub. Date: May 7, 2026

(54) METHOD FOR OPERATING A SUPPLY SYSTEM AND SUPPLY SYSTEM

(71) Applicant: ZF Friedrichshafen AG, Friedrichshafen (DE)

(72) Inventors: Sebastian Heine, Wangen (DE); Markus Eisele, Friedrichshafen (DE); Roland Mair, Tettnang (DE); Andreas Acker, Meckenbeuren (DE)

(73) Assignee: ZF Friedrichshafen AG, Friedrichshafen (DE)

(21) Appl. No.: 19/377,586

(22) Filed: Nov. 3, 2025

(30) Foreign Application Priority Data
Nov. 4, 2024 (DE) 10 2024 210 553.8

(51) Int. Cl. F16H 57/04

(52) U.S. Cl. CPC F16H 57/0439; F16H 57/0435; F16H 57/0442; F16H 57/0471; F16H 57/0445

(57) ABSTRACT

A method is provided for operating a supply system in which drive system components are supplied with lubricant and/or coolant. During normal operation of the drive system, an electrically powered feed pump is operated to deliver lubricant and/or coolant in the supply system to the drive system components. During a special operating mode, the electrically powered feed pump is switched off while the drive system is still operating so that at least some of the drive system components are supplied with lubricant and/or coolant only by a mechanically driven feed pump that is driven by a drive output of a motor vehicle drivetrain comprising the drive system. In this case, during operation, the mechanically driven feed pump only delivers a minimum quantity of lubricant and/or coolant that corresponds to a minimum demand required for supplying some of the components.

### RELATED APPLICATIONS

This application claims the benefit of and right of priority under 35 U.S.C. § 119 to German Patent Application no. 10 2024 210 553.8, filed on 4 Nov. 2024, the contents of which are incorporated herein by reference in its entirety.

### FIELD OF THE DISCLOSURE

The invention relates to a method for operating a supply system, in which components of a drive system are supplied with a lubricant and/or coolant, wherein during the normal operation of the drive system an electrically powered feed pump is operated and thereby, by way of the electrically powered feed pump, a lubricant and/or coolant in the supply system is delivered to the components, and wherein, during a special operation in which the electrically powered feed pump is switched off while the drive system is still operating, at least some of the components in the supply system are supplied with a lubricant and/or coolant by means of a mechanically driven feed pump. In addition, the invention relates to a supply system by which components of a drive system can be supplied with a lubricant and/or coolant.

### BACKGROUND

In drivetrains, by means of supply systems it is usual in each case for components to be supplied with a lubricant and/or coolant in order to lubricate and/or cool the individual components and/or to operate the individual components by virtue of the supply. In most cases, a supply system is then designed as a hydraulic system in which a hydraulic fluid is supplied, which fluid is usually oil. During the operation of the drive system concerned, to the extent possible, a sufficient supply of the individual components should be ensured at all times. More and more often supply systems comprise electrically powered feed pumps, although in some cases, in addition to the electrically powered feed pump a mechanically driven feed pump is also provided so that in the event of a malfunction or similar, it remains possible to supply at least some of the components by way of the supply system.

For example, EP 2 855 928 B1 discloses a supply system for a drive system in the form of a transmission of a wind-power unit. In this case, components in the form of bearings and gearwheels can be supplied with lubricant by the supply system, and for that supply, besides an electrically powered feed pump, a mechanically driven feed pump is also provided. In the context of a method, the supply system of EP 2 855 928 B1 can be operated in such manner that during the normal operation of the transmission, the electrically powered feed pump is supplied with electrical energy and thereby lubricant is delivered to the bearings and gearwheels by the two feed pumps. Furthermore, in a special operational mode in which the operation of the electrically powered feed pump is prevented during the active operation of the transmission because the electrical energy supply has failed, only some of the components, namely, the bearings of the transmission, are supplied with lubricant by the mechanically driven feed pump acting on its own.

### SUMMARY

Starting from the above-mentioned prior art, it is now the purpose of the present invention, in the case of a supply system of a drive system, on one hand to keep losses as small as possible, and on the other hand, to avoid damage to components of the drive system that would otherwise take place owing to insufficient lubricant supply.

From a process-technological standpoint, this objective is achieved starting from methods of the present disclosure. In addition, from the equipment standpoint, the objective is achieved by a supply system as disclosed herein. Advantageous further developments will be apparent in light of the present disclosure.

According to the present disclosure, in a method for operating a supply system, components of a drive system are supplied with lubricant and/or coolant. For this, during normal operation of the drive system an electrically powered feed pump is operated and thereby, by way of the electrically powered feed pump, in the supply system lubricant and/or coolant is/are delivered to the components. In contrast, during a special operating mode in which while the drive system is operating the electrically powered feed pump is switched off, by means of the supply system at least some of the components are supplied with lubricant and/or coolant by means of a mechanically driven feed pump.

Thus, during the normal operation of the drive system the supply system is operated in such manner that the components are supplied by an electrically powered feed pump which, in the supply system, is supplied with electrical energy for that purpose and thereby delivers lubricant and/or coolant to the components. On the other hand, the special operating mode takes place if, during the active operation of the drive system, the electrically powered feed pump is not operated so that then the electrically powered feed pump does not deliver any lubricant and/or coolant. Instead, during the special operating mode only a mechanically drive feed pump is operated, which thereby delivers lubricant and/or coolant and ensures the supply of at least some of the components with the required lubricant and/or coolant.

According to the invention, the special operating mode always takes place when the electrically powered feed pump is not operating while the drive system is still in operation. Thus, the special operating condition can be initiated selectively when the electrical energy supply to the electrically powered feed pump is intentionally cut off, or it can be an operating condition that takes place in the event of a fault, for example a breakdown of the electrically powered feed pump or a failure of its energy supply.

According to a method of the present disclosure, the invention now incorporates the technical principle that the mechanically driven feed pump is driven by a drive output of a motor vehicle drivetrain comprising the drive system. When it is operating, the mechanically driven feed pump delivers only a minimum quantity that corresponds to the minimum required for supplying the particular components concerned. In other words, the mechanically driven feed pump is driven by a drive output contained in a drivetrain that comprises the drive system. While it is being driven, the mechanically driven feed pump provides only a minimum quantity of lubricant and/or coolant that corresponds to a minimum lubricant and/or coolant demand for the particular components concerned.

The operation of a supply system in accordance with the invention has the advantage that on the one hand at least some components continue being supplied by means of the mechanically driven feed pump even if, while the drive system is operating, no supply is or can be delivered by the electrically powered feed pump. Thereby, by virtue of the supply system, impairment or even damage at least to some of the components due to otherwise insufficient supply can be prevented. However, since the mechanically driven feed pump delivers only a minimum quantity while it is operating, losses are also minimized which would otherwise be caused by too high a level of lubricant and/or coolant in the supply system and in particular by splashing produced by the rotation of immersed components. All-in-all, therefore, on the one hand the supply system operates more efficiently, and on the other hand, at least for some of the components, a permanent minimum supply level is ensured.

The drive system whose components have to be supplied is at least part of a drivetrain of a motor vehicle, wherein the drive system can specifically be a motor vehicle transmission, a motor vehicle drive axle and in that case in particular an electrically powered motor vehicle drive axle, etc. The mechanically driven feed pump is powered for its operation by a drive output of the motor vehicle drivetrain, for which purpose the mechanically driven feed pump is coupled during its operation to a drive output of the drive system. In this case the drive output is preferably a component such as a transmission output shaft which is permanently coupled to a drive-wheel of the motor vehicle drivetrain.

When the mechanically driven feed pump is powered by the drive output, the mechanically driven feed pump delivers only a certain minimum quantity of lubricant and/or coolant. The minimum quantity is chosen such that it corresponds to a minimum demand of the components concerned without impairment of or damage to the components. Accordingly, the mechanically driven feed pump is designed to deliver only the minimum amount.

In accordance with an embodiment of the invention, during normal operation the mechanically driven feed pump is operated in addition to the electrically powered feed pump. Thereby, during normal operation the components are advantageously supplied conjointly by both pumps. For that purpose, the mechanically driven feed pump is in particular permanently drivingly coupled to the drive output.

In a possible design alternative to the above, during normal operation the mechanically driven feed pump is decoupled from the drive output and therefore disconnected. In that way losses in the supply system can be reduced during normal operation since there is no drive output to the mechanically driven feed pump. In a further development of this possible design, the mechanically driven feed pump is decoupled as a function of a pressure in the supply system and/or by means of an actor. Thus, a pressure-controlled coupling or an actor-controlled coupling could be provided, wherein the actor could also activate the coupling as a function of the pressure. The pressure in the supply system is in particular a pressure existing on a pressure side of the electrically powered feed pump.

In a further embodiment of the invention, during the special operating mode only those components are supplied for which it is essential to supply permanently during the operation of the drive system. Consequently, during special operation the supply is restricted to the components which have to be supplied during the special operating mode. In that way the minimum quantity to be delivered can be kept small while nevertheless excluding damage to the components of the drive system.

In a further development of the invention, during normal operation the electrically powered feed pump delivers only as much as is required. In that way the efficiency can be improved even during normal operation, since the electrically powered feed pump covers only the actual demand for lubricant and/or coolant.

According to a supply system of the present disclosure, components of a drive system can be supplied with lubricant and/or coolant. Furthermore, an electrically powered feed pump and a mechanically driven feed pump are provided, such that the electrically powered feed pump delivers lubricant and/or coolant to the components during the normal operation of the drive system in the supply system. In addition, during a special operating mode in which the electrically powered feed pump is switched off while the drive system is in operation, the mechanically driven feed pump on its own supplies some of the components with lubricant and/or coolant.

In the supply system, components of the drive system are supplied with lubricant and/or coolant, wherein the components to be supplied are components that have to be lubricated and/or components that have to be cooled and/or components that have to be both lubricated and cooled. In principle the components can be in the form of a bearing such as a slide bearing or a roller bearing, a transmission stage in which engaged gearwheels must be lubricated, a rotor or a stator of an electric machine, etc. The lubricant and/or coolant to be delivered is in particular a fluid and especially preferably oil.

In the context of the invention, an “electrically powered feed pump” is understood to be a feed pump to drive which electrical energy has to be supplied. In contrast, a “mechanically driven feed pump” is understood to be a feed pump to drive which mechanical energy has to be supplied.

According to the supply system, in accordance with some embodiments, the invention incorporates the technical principle that the mechanically driven feed pump is driven by a drive output of a motor vehicle drivetrain which includes the drive system. Furthermore, when it is driven the mechanically driven feed pump delivers only a minimum quantity that corresponds to the minimum demand required for supplying the components concerned. In other words, the mechanically driven feed pump is driven by a drive output comprised in a motor vehicle drivetrain which contains the drive system. Moreover, the mechanically driven feed pump is designed such that when it is driven, it delivers only a minimum quantity that corresponds to a minimum demand of lubricant and/or coolant for supplying at least the components concerned.

Advantageously, with the supply system designed in accordance with the invention, a minimum supply to at least some of the components can be realized, in that if the operation of the electrically powered feed pump is interrupted during the active operation of the drive system, then by means of the mechanically driven feed pump a corresponding supply can be delivered. In that way, if the electrically powered feed pump in the supply system is not operating, there will be no impairment or damage at least of the components concerned, which would otherwise take place due to inadequate lubrication. However, since the mechanically driven feed pump when it is operating covers only the minimum demand, losses are also minimized which would otherwise be caused by too high a level of lubricant and/or coolant and in particular by splashing produced by the rotation of immersed components. All-in-all, therefore, a supply system can be provided which can be operated efficiently and with which, at least for some of the components, a minimum necessary supply is always ensured.

In a further development of the invention, between the mechanically driven feed pump and the drive output there is arranged a clutch, by means of which the mechanically driven feed pump can be decoupled from the drive output. Thus, in that case, the mechanically driven feed pump is not permanently drivingly coupled to the drive output, but can be coupled thereto by means of the interposed clutch. In that way, during normal operation the mechanically driven feed pump can be selectively decoupled and its operation thereby prevented, whereby losses can be reduced and the efficiency consequently increased. Preferably the clutch is controlled as a function of a pressure present in the supply system and/or it can be actuated by an actor.

Alternatively, however, the mechanically driven feed pump can be permanently coupled to the drive output of the drive system.

### BRIEF DESCRIPTION OF THE DRAWINGS

Advantageous embodiments, which are explained in what follows, are illustrated in the drawings, which show:

FIG. 1: A schematic representation of a motor vehicle which comprises a supply system corresponding to a first embodiment of the invention; and

FIG. 2: A schematic representation of a motor vehicle with a supply system according to a second possible design of the invention.

### DETAILED DESCRIPTION

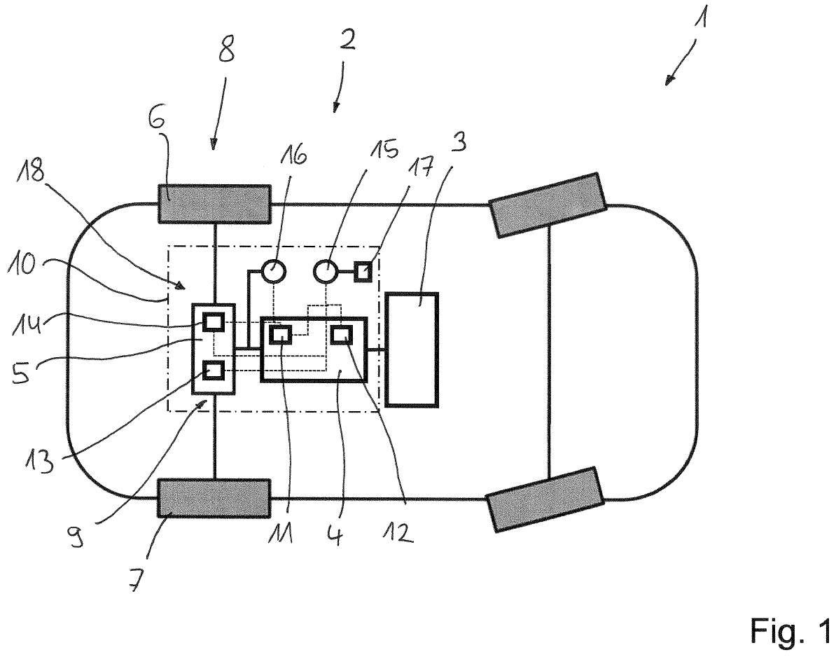

FIG. 1 shows a schematic representation of a motor vehicle 1, which can be a passenger car or even a utility vehicle. The motor vehicle 1 comprises a motor vehicle drivetrain 2 in which a drive machine 3 can be or is coupled on the drive output side via a transmission 4 and a differential gearbox 5 to drive wheels 6 and 7 of a motor vehicle drive axle 8. The drive machine 3 can be an internal combustion engine or even an electric machine.

Associated with the transmission 4 and the differential gearbox 5, which form part of the drive system 9 of the motor vehicle drivetrain 2, there is a supply system 10 by means of which components 11, 12, 13, and 14 of the drive system 9 can be supplied with lubricant in the form of oil. In this case, the supply system 10 is designed in accordance with a first embodiment of the invention. Here, the component 11 is a bearing of the transmission 4, the component 12 is a gearset of the transmission 4, the component 13 is a bearing of the differential gearbox 5, and the component 14 is a gearset of the gearbox 5.

The supply system 10 has an electrically powered feed pump 15 and a mechanically driven feed pump 16, wherein the electrically powered feed pump 15 is associated with an electric machine 17 which, when supplied with electrical energy, drives the electrically powered feed pump 15. During its operation the electrically powered feed pump 15 draws oil from a reservoir of the supply system 10—not shown in this case—and then delivers the oil to the components 11 to 14, while during this the delivery is controlled according to need by regulating the electric machine 17, and hence also the electrically powered feed pump 15.

The mechanically driven feed pump 16 is drivingly connected between the transmission 4 and the differential gearbox 5 and thereby also coupled permanently to a drive output 18 of the motor vehicle drivetrain 2. In this case, the drive output 18 is in the form of the permanent coupling via the differential gearbox 5 to the drive wheels 6 and 7. A drive input to the mechanically driven feed pump 16 is provided by the drive torque acting between the transmission 4 and the differential gearbox 5, so that when driven the mechanically driven feed pump 16 draws oil out of the reservoir of the supply system 10 and delivers it to some of the components 11 to 14, namely, the components 11 and 14. In this case, the mechanically driven feed pump 16 is designed to delver a minimum quantity, i.e., it exactly covers a minimum oil demand required for supplying the two components 11 and 14.

During a normal operation of the motor vehicle drivetrain 2, and therefore also of the drive system 9, i.e., when the motor vehicle 1 is driving normally, the electrically powered feed pump 15 of the supply system 10 is driven by the electric machine 17 and at the same time there is a drive input to the mechanically driven feed pump 16 by virtue of its connection between the transmission 4 and the differential gearbox 5. Thus, both feed pumps 15 and 16 together deliver oil to the components 11 and 14, whereas the components 12 and 13 are supplied by the electrically powered feed pump 15 alone. In this case therefore, by means of the electrically powered feed pump 15, a supply according to need takes place in which, as regards the components 11 and 14, the minimum demand already covered by the mechanically driven feed pump 16 is taken into account.

However, instead of the normal operation, a special operating mode of the motor vehicle drivetrain 2, and thus also of the drive system 9, can also take place. This is the case when although the motor vehicle 1 is still moving, its ignition is switched off or the power of the motor vehicle drivetrain 2 has been selectively reduced. The first of these can happen, for example, when the motor vehicle 1 is being pulled or towed, whereas the power reduction can be necessary in particular if there is a fault.

During the special operating mode no drive power is supplied to the electrically powered feed pump 15, whereas owing to its permanent coupling to the drive output 18, the mechanically driven feed pump 16 continues delivering oil to the components 11 and 14. Thereby, while the motor vehicle 1 is moving, an at least necessary supply to the components 11 and 14 is ensured and thus their impairment or damage is also prevented.

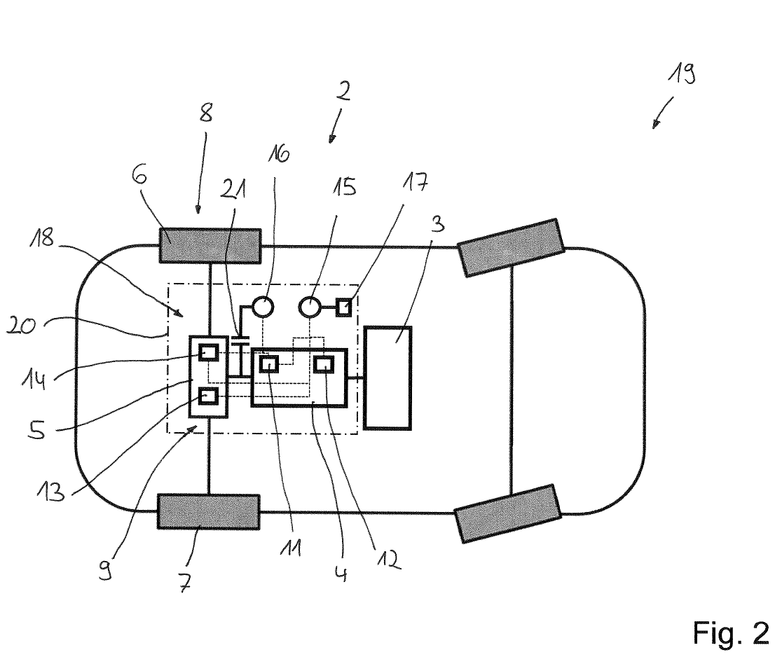

FIG. 2 shows a schematic view of a motor vehicle 19 that corresponds in large measure to the variant shown in FIG. 1. The only difference compared with the variant in FIG. 1 is that in a supply system 20 the mechanically driven feed pump 16 is now not permanently connected between the transmission 4 and the differential gearbox 5, but instead can only be so connected by closing an intermediate clutch 21.

The clutch 21 is only closed during the special operating mode of the motor vehicle drivetrain 2 of the motor vehicle 19, so that the mechanically driven feed pump 16 also only then delivers oil to the components 11 and 14. On the other hand, when the motor vehicle drivetrain 2 is operating normally, the clutch 21 decouples the mechanically driven feed pump 16 from the drive output 18 so that delivery by the feed pump 16 is discontinued. In that case the components 11 to 14 are supplied by the electrically powered feed pump 15 alone.

The clutch 21 can be controlled by an actor—not shown here—or as a function of the pressure provided in the supply system 20 by the electrically powered feed pump 15. In other respects, the motor vehicle 19, and in particular also the supply system 20, corresponds to the variant shown in FIG. 1, so that reference can be made to the description thereof.

By virtue of the variants of a drive system according to the invention, on the one hand losses can be kept as low as possible, and on the other hand damage to components of the drive system caused by inadequate supply is avoided.

### INDEXES

1 Motor vehicle
2 Motor vehicle drivetrain
3 Drive machine
4 Transmission
5 Differential gearbox
6 Drive wheel
7 Drive wheel
8 Motor vehicle drive axle
9 Drive system
10 Supply system
11 Component
12 Component
13 Component
14 Component
15 Electrically powered feed pump
16 Mechanically driven feed pump
17 Electric machine
18 Drive output
19 Motor vehicle
20 Supply system
21 Clutch

1. A method for operating a supply system (10; 20), in which components (11, 12, 13, 14) of a drive system (9) are supplied with lubricant and/or coolant, the method comprising:
operating an electrically powered feed pump (15) during normal operation of the drive system (9) thereby delivering lubricant and/or coolant in the supply system (10; 20) to the components (11, 12, 13, 14);
switching off the electrically powered feed pump (15) while the drive system (9) is still operating;
supplying at least some components (11, 14) of the components (11, 12, 13, 14) in the supply system (10; 20) with lubricant and/or coolant only by a mechanically driven feed pump (16);
driving the mechanically driven feed pump (16) by a drive output (18) of a motor vehicle drivetrain (2) comprising the drive system (9); and
delivering, when the mechanically driven feed pump (16) is operating, only a minimum quantity of lubricant and/or coolant that corresponds to a minimum demand required for supplying the at least some components (11, 14) of the components (11, 12, 13, 14).

2. The method according to claim 1, wherein the normal operating mode includes operating the mechanically driven feed pump (16) in addition to the electrically powered feed pump (15).

3. The method according to claim 1, comprising:
decoupling, during the normal operating mode, the mechanically driven feed pump (16) from the drive output (18), thereby turning off the mechanically driven feed pump (16).

4. The method according to claim 3, wherein decoupling the mechanically driven feed pump (16) is performed as a function of a pressure in the supply system (10; 20).

5. The method according to claim 1, wherein during the special operating mode only the at least some components (11, 14) of the components (11, 12, 13, 14) are supplied to which it is essential to supply lubricant and/or coolant permanently while the drive system (9) is operating.

6. The method according to claim 1, comprising:
delivering, by the electrically powered feed pump during normal operation, only as much lubricant and/or coolant as is required.

7. A supply system (10; 20), in which configured to supply components (11, 12, 13, 14) of a drive system (9) with lubricant and/or coolant, the supply system comprising:
an electrically powered feed pump (15);
a mechanically driven feed pump (16) having a drive input; and
a drive output of a motor vehicle drivetrain that includes the supply system, the drive output coupled to the drive input to drive the mechanically driven feed pump (16);
wherein during normal operation of the drive system (9) the electrically powered feed pump (15) in the supply system (10; 20) is configured to deliver lubricant and/or coolant to the components (11, 12, 13, 14), and
wherein, during a special operating mode in which the electrically powered feed pump (15) is switched off while the drive system (9) is still operating, the mechanically driven feed pump (16) alone is configured to supply at least some (11, 14) of the components (11, 12, 13, 14) with lubricant and/or coolant,
wherein when driven by the drive output, the mechanically driven feed pump (16) delivers only a minimum quantity of lubricant and/or coolant that corresponds to a minimum demand required for supplying the lubricant and/or coolant to at least those (11, 14) of the components (11, 12, 13, 14) concerned.

8. The supply system (20) according to claim 7, comprising a clutch (21) arranged between the mechanically driven feed pump (16) and the drive output (18), by means of which clutch the mechanically driven feed pump (16) can be decoupled from the drive output (18).

9. The supply system (20) according to claim 8, wherein the clutch (21) is configured to be controlled as a function of a pressure present in the supply system (20) and/or actuated by an actor.

10. The supply system (10) according to claim 7, wherein the mechanically driven feed pump (16) is permanently coupled to the drive output (18).
